(19) United States
(12) Patent Application Publication
(10) Pub. No.: US 2003/0091276 A1
(43) Pub. Date: May 15, 2003

(54) Grating-based MUX/DMUX with expanded waveguides

(75) Inventors: Qi Wang, Burnsville, MN (US); Boying Barry Zhang, Lawrenceville, NJ (US); Pingfan P. Wu, Willingboro, NJ (US)

Correspondence Address: ALTERA LAW GROUP, LLC, 6500 CITY WEST PARKWAY, SUITE 100, MINNEAPOLIS, MN, 55344-7704, US

(73) Assignee: ADC Telecommunications, Inc.

(21) Appl. No.: 10/010,816

(22) Filed: Nov. 13, 2001

(51) Int. Cl. G02B 6/26; G02B 6/293

(52) U.S. Cl. 385/31; 385/24; 385/43

(57) ABSTRACT

A grating-based MUX/DMUX reduces temporal distortion. In one embodiment, and optical device that has a multi-channel port and a plurality of single-channel ports. At least one of the multi-channel port and the single-channel ports include a waveguide with a cross-sectional dimension that is smaller at an internal portion of the waveguide than at an aperture of the waveguide. An optical system has wavelength-dependent, free-space paths that couple light between the single-channel ports and the multi-channel ports. The waveguide aperture is coupled to one of the wavelength-dependent, free-space paths.

### FIELD OF THE INVENTION

The present invention is directed generally to optical communications, and more particularly to the separation and combination of channels in wavelength division multiplexed and dense wavelength division multiplexed communications systems.

### BACKGROUND

One of the advantages of optical fiber communication is the potential for large information handling capacity. One approach to increasing the optical bandwidth over which information is transmitted in an optical fiber is to use wavelength division multiplexing (WDM), where light at several different wavelengths is combined and injected into a fiber, the light at each wavelength typically being independently modulated with information prior to combining with the other wavelengths. After propagation through the fiber, the light is then separated into its different wavelength components before detection. The International Telecommunications Union (ITU) has set WDM standards that specify the operating wavelengths for the different WDM components, also known as channels. Under these standards, the separation between adjacent channels is typically a fixed frequency. For example, the inter-channel spacing may be 100 GHz or 50 GHz.

Within an individual wavelength channel of a WDM system, the signal fidelity may be adversely affected by optical loss and temporal distortion as it travels through the optical fiber, and various transparent routing components such as multiplexers, optical interleavers, switches, demultiplexers, and the like. It is highly desirable to minimize these effects in both component-level and system-level design.

Deleterious amplitude effects include linear losses that are caused by bulk absorption and incomplete reflection. Additionally, nonlinear optical effects may transfer power out of a channel or mix the signals in different channels when the signal intensity exceeds a critical value giving rise to interchannel crosstalk. Temporal distortion such as pulse spreading may be produced by dispersion in the optical fiber or other effects that cause different spectral components of the optical signal to travel at different speeds through the system. For example, conventional grating-based optical multiplexers (MUX) and demultiplexers (DMUX) often utilize free space optical systems and signals are often temporally-distorted as they pass through the device. This distortion results from a grating diffraction in which the angle between the incident beam and the surface normal is not equal to the angle between the normal and the diffracted beam.

As data rates are increased and the channel wavelength separation is reduced, both amplitude and temporal distortion must be minimized throughout the optical transport system. Reduced fiber dispersion may be achieved by operating in the 1.5 μm communications band. In addition, it is essential to minimize temporal dispersion in transparent routing components.

Accordingly, there is a need for grating-based MUX and DMUX components with reduced temporal distortion. These components should also reduce interchannel crosstalk, have high optical transmission and an amplitude transfer function that is flat throughout the wavelength band of interest.

### SUMMARY OF THE INVENTION

Generally, the invention relates to a grating-based MUX/DMUX that reduces temporal distortion. One embodiment of the invention is directed to an optical device that has a multi-channel port and a plurality of single-channel ports. At least one of the multi-channel port and the single-channel ports include a waveguide with a cross-sectional dimension that is smaller at an internal portion of the waveguide than at an aperture of the waveguide. An optical system has wavelength-dependent, free-space paths that couple light between the single-channel ports and the multi-channel ports. The waveguide aperture is coupled to one of the wavelength-dependent, free-space paths.

In another embodiment of the invention, an optical wavelength division multiplexed (WDM) communications system includes a WDM transmitting unit, a WDM receiving unit and an optical transport system coupled to transmit a multi-channel optical signal from the transmitting unit to the receiving unit. At least one of the transmitting unit and the receiving unit has an optical device that includes a multi-channel port and a plurality of single-channel ports. At least one of the multi-channel and the single-channel ports has a waveguide with a cross-sectional dimension that is smaller at an internal portion of the waveguide than at an aperture of the waveguide. An optical system with wavelength-dependent, free-space paths couples light between the single-channel ports and the multi-channel ports. The waveguide aperture is coupled to one of the wavelength-dependent, free-space paths.

Another embodiment of the invention is directed to a method of forming a multi-channel optical signal. The method comprises optically coupling a plurality of single-channel ports to a multi-channel port along wavelength-dependent free-space optical paths. The method also includes reducing the angular spread of the free-space optical path at a coupling aperture of at least one of the plurality of single-mode ports and the multi-frequency port by including a waveguide with a cross-sectional dimension that is smaller at an internal portion of the waveguide than at the aperture of the waveguide in the port.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

FIG. 1 schematically illustrates a wavelength division-multiplexed (WDM) fiber optics communications system.

FIG. 2 is a schematic representation of a fiber optic system for the transport of optical signals between transmitting and receiving stations.

FIG. 3 is a schematic representation of a free space system for the transport of optical signals between transmitting and receiving stations.

FIG. 4 schematically illustrates an optical wavelength multiplexer utilizing a single converging optical subsystem.

FIGS. 5A and 5B respectively illustrate different diffraction grating arrangements in the optical wavelength multiplexer of FIG. 4.

FIG. 6 schematically illustrates an optical wavelength multiplexer utilizing two converging optical subsystems.

FIG. 7 schematically illustrates the wavefront distortion resulting from a grating reflection with unequal incident and reflective angles.

FIG. 8A illustrates an optical pulse shape incident on a reflecting surface.

FIGS. 8B and 8C respectively illustrate the shape of the optical pulse after reflection by a mirror and diffraction by a grating.

FIG. 9A and 9B respectively illustrate the divergence of light beams emerging from conventional and core-expanded single-mode fibers.

FIG. 10 schematically illustrates an embodiment of an optical wavelength multiplexer according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical communications systems, and is believed particularly suited to combining and/or separating optical communications channels in a wavelength division-multiplexed fiber-optic communications system.

Wavelength division multiplexed (WDM) systems include several channels of light at different optical frequencies. In terrestrial fiber optic networks, the International Telecommunications Union (ITU) has set standards for the operating wavelengths of the channels in a WDM network. According to these standards, individual wavelengths are separated by a fixed frequency, Δf, that may be, for example, equal to 50 GHz or 100 GHz. Thus, frequencies of individual channels, fₘ, m=0,1,2,3,4 . . . , satisfy the following relationship:

fₘ=f₀+mΔf.

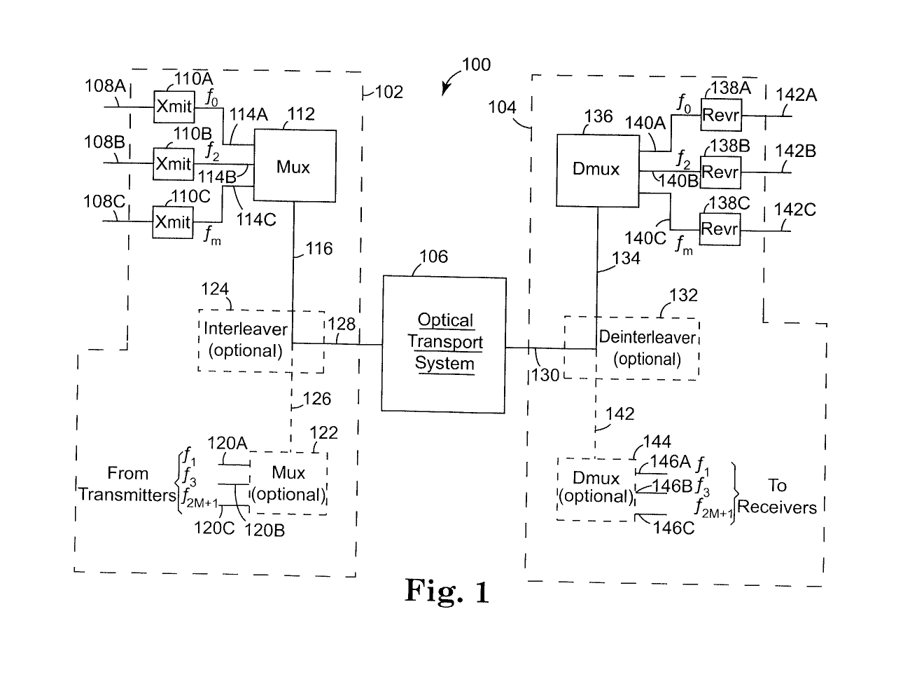

FIG. 1 is a schematic representation of a typical WDM optical communication system 100 that is designed to transport a plurality of information signals from a transmitter unit 102 to a receiver unit 104. Signals are transported between the transmitter unit 102 and receiver unit 104 by an optical transport system 106. The optical transport system may, for example, be a guided wave system or a free space propagation system or a hybrid system. Input information signals may be carried to the transmitting station by inputs 108A-108C. These input signals may then be converted to modulated lightwave beams by modulating the output from respective laser transmitters 110A-110C according to the input signals. The laser transmitters 110A-110C may operate at output frequencies that are assigned according to an established standard (the ITU standard, for example). Thus, electronic information carried to the transmitter unit 102 by the input line 108A may be converted to an optical signal having a light frequency, f₀ by the laser transmitter 110A. Other inputs 108B and 108C may similarly be converted to optical signals with different frequencies, f₂ and f₂ₘ. The wavelength separation between even-numbered channel frequencies is fixed and equal to 2Δf. While m is illustrated to be 2 in FIG. 1, corresponding to only three inputs, it may be larger.

Optical output signals from the laser transmitters 110A-110C are typically carried to an optical wavelength multiplexer (MUX) 112 by optical fibers 114A-114C. The MUX 112 combines the single-channel inputs from optical fibers 114A-114C into a multi-channel output signal that is carried from the MUX 112 by an output optical fiber 116.

Optionally, output signals with odd-number frequencies f₂ₘ₊₁ may be generated by a second set of transmitters that are not shown in FIG. 1 and carried to the inputs of a second MUX 122 by optical fibers 120A-120C. The MUX 122 combines the signals carried by the optical fibers 120A-120C into a single multichanneled output signal that is carried to an optical interleaver 124 by the optical fiber 126.

Individual channels in the WDM outputs of the MUX units 112 and 122 are typically separated by a frequency difference equal to 2Δf. The odd-numbered frequencies of the channels in the signal output from the second MUX 122 are also typically offset from the even-numbered frequencies of the channels of the first MUX 112 by Δf. The optical interleaver 124 combines the multi-channel signals carried by the output optical fibers 116 and 126 into a single WDM multi-channel output that is transported from the transmitting station by the optical fiber 128. The channel frequency separation of the WDM multichannel signal output from the interleaver 124 is equal to Δf.

Optical signals from the transmitting unit 102 are transported to the receiver unit 104 by an optical transport system 106. An optical fiber 130 carries the WDM signal from the optical transport system 106 to the receiver unit 104. Channels with even-numbered frequencies from the first MUX 112 and channels with odd-numbered frequencies from the second MUX 122 may first be separated by a deinterleaver 132. Even-numbered channels are output from the deinterleaver 132 on the optical fiber 134, and are subsequently separated into single channel outputs by the optical demultiplexer (DMUX) 136. Single-channel output signals are typically carried from the DMUX to the optical receivers 138A-138C by optical fibers 140A-140C. The optical receivers 138A-138C detect the respective single channel signals directed from the DMUX 136.

Odd-numbered signals that leave the deinterleaver on the optical fiber 142 are separated in a similar fashion by a second DMUX 144 and are carried to single-frequency optical receivers by the optical fibers 146A-146C. Interleaving need not be used, in which case the dotted-line components may be removed from the system.

WDM systems having an architecture like that illustrated in FIG. 1 may operate over a wide range of optical wavelengths. Commonly, signals are transported within a wavelength band that may be centered near 0.860 μm, 1.3 μm, or 1.5 μm. Systems may also be designed to carry signals that are widely separated in wavelength, for example at 1.31 μm and 1.5 μm.

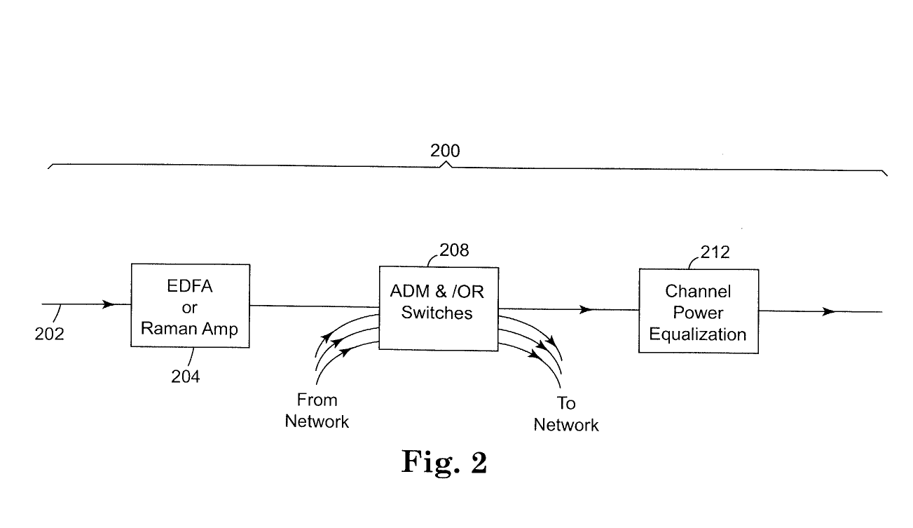

FIG. 2 shows a schematic representation of a guided-wave optical transport system 200 that may be used to connect transmitting and receiving units in a WDM fiber communications system. Applications for such a system may include high bandwidth Internet communications, audio or video communications, and the transfer of cable-access television (CATV) signals between headend and nodal stations in a cable television distribution network.

In FIG. 2, a WDM signal or dense wavelength division multiplexed (DWDM) signal having reduced channel spacing relative to a WDM signal is carried from the transmitting unit to the receiving unit by an optical fiber 202. In applications where the information is transmitted over large distances, one or more erbium-doped fiber amplifiers and/or fiber Raman amplifiers 204 may be used to increase the signal power, thereby compensating for optical fiber and connector losses. In network applications, switching devices 208, such as optical on/off switches, optical pass through switches, static optical add-drop multiplexers, configurable optical add-drop multiplexers and optical cross connect switches may used to change the paths of single channel and/or multi-channel signals. Spectral anisotropies in the gain and/or loss spectrum of the transport system components may also be corrected by the inclusion of one or more optical power equalizers 212. These devices measure optical power in each channel and add an appropriate amount of gain or loss to each channel to flatten the power spectrum of the WDM signal. Depending on the application, fiber communications systems operating near 1.5 μm may carry optical signals over hundreds of kilometers or interconnect a number of digital workstations within a single building.

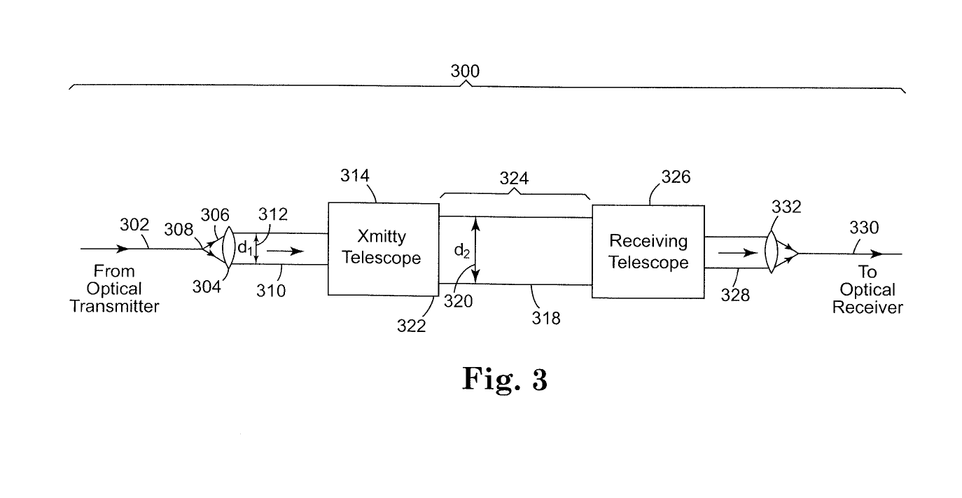

FIG. 3 is a schematic representation of a free-space optical transport system 300 that may be used, for example, to transfer information between two satellites or between a satellite and a ground station. Free space links may also be used for terrestrial communication.

In FIG. 3, an optical fiber 302 carries the signal generated by a WDM or DWDM transmitting station to a converging optical system 304. Divergent light 306 entering from the fiber end 308 is collected by the converging optical system and converted to a collimated free-space beam 310 with diameter, d₁, 312. A transmitting telescope 314 further decreases the divergence of the free space beam 310 by expanding it to an output beam 318 with a diameter, d₂, 320, where d₁<d₂. In a satellite link, for example at 0.860 μm, the beam 310 leaving the converging optical system 304 may have a 1/e beam diameter, d₁, 312 of 4 or 5 mm, while diameter, d₂, 320 of the beam 318 at the telescope output 322 may be 100 mm or greater. Since expansion of the diameter of the free space beam 318 is in direct proportion to the cross sectional area of the free space beam 318 at the telescope output 322, beam expansion by the transmitting telescope 314 reduces divergence of the free space beam 318 as it traverses the optical path 324. At the receiving end, a receiving telescope 326 collects the light from the transmitting telescope 314, producing a small-diameter free space beam 328 that is focused into the output optical fiber 330 by the output optical system 332. It will be appreciated that other optical configurations for directing an optical signal over a free-space link may be used, in addition to those presented in FIG. 3.

Multiplexing operations are typically performed by assemblies of transparent and reflective optical components that are designed to combine physically-separate, single-wavelength beams into a single beam that can be coupled into an optical fiber. Demultiplexers perform the inverse process, physically separating the single wavelength channels of a multifrequency WDM or DWDM signal. For example, multiplexing may be accomplished by using a diffraction grating and converging optical system in a Littrow or Littman-Metcalf configuration.

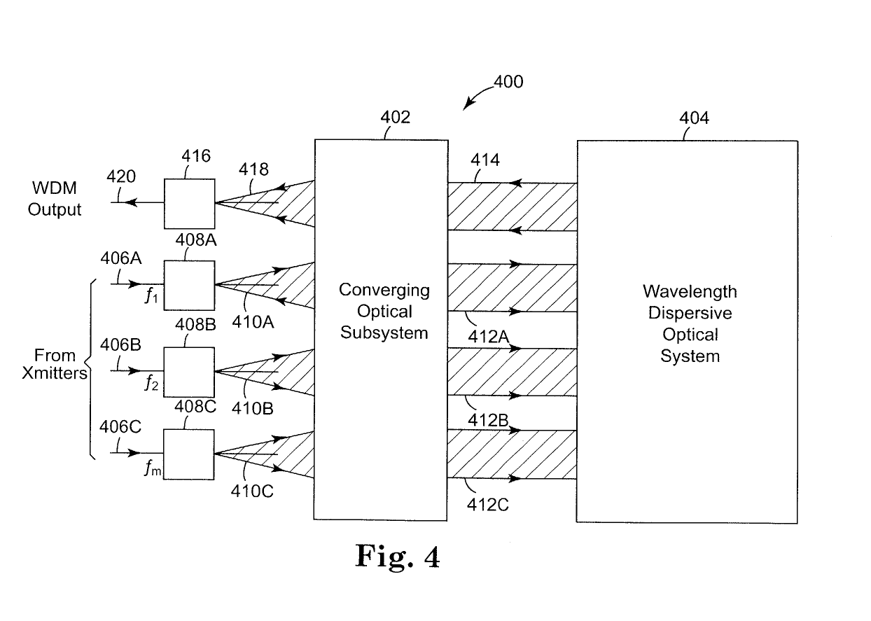

FIG. 4 is a schematic representation of a MUX 400 that includes a single converging optical subsystem 402 and a wavelength-dispersive optical system 404. In the MUX 400, optical fibers 406A-406C carry single-channel signals from a plurality of transmitters (not shown) to the single-channel I/O ports 408A-408C. Each input beam is assumed to have a unique center frequency, fₘ, that is in a known relationship to the other inputs. For example, according to the ITU standard, adjacent center frequencies are separated by a fixed amount:

fₘ₊₁−fₘ=Δf.

Single-channel beams 410A-410C exiting the single-channel ports 408A-408C are collimated by the converging optical system 402. The collimated beams 412A-412C from the converging optical subsystem are combined by wavelength-dispersive optical system 404 and directed back to the converging optical subsystem 402 as a multi-channel beam 414. The converging optical subsystem 402 focuses the multi-channel beam 414 on the multi-channel port 416 that couples the converging multi-channel beam 418 to the output fiber 420.

A demultiplexing function may be performed by the same device operated in the reverse direction. In other words, the MUX 400 may couple a multi-channel signal entering through the multi-channel port 416 to a plurality of spatially-separated single channel signals that are imaged onto the single channel ports 406A-406C.

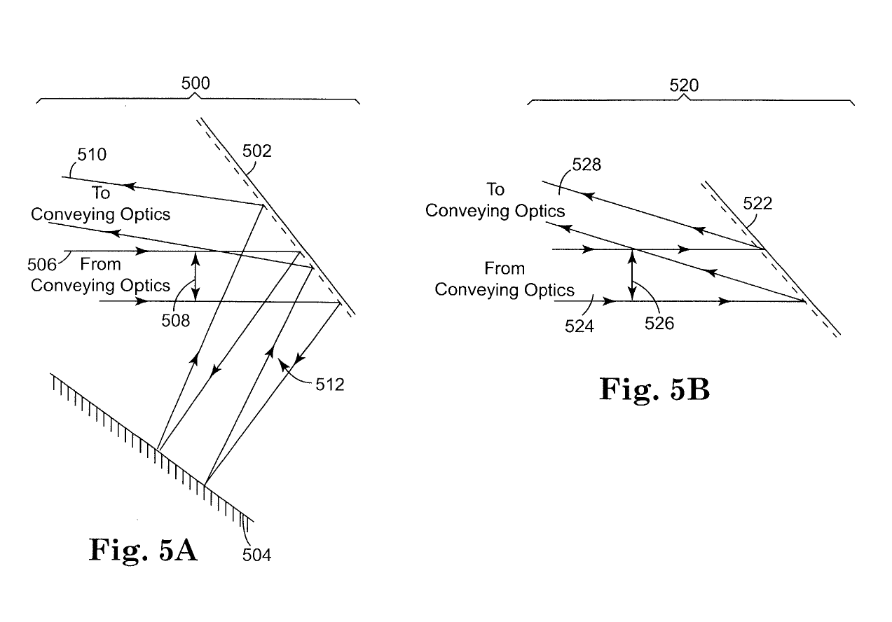

FIG. 5A shows a wavelength-dispersive optical system 500 that includes a diffraction grating 502 and plane reflector 504 disposed in a configuration referred to hereafter as a Littman-Metcalf configuration. An input light beam 506, that may be approximately collimated with a dimension 508 in the plane of FIG. 5A, is coupled to the output beam 510 along a wavelength dependent optical path 512. Light propagating along the wavelength dependent optical path 512 interacts with the grating 502 and is diffracted a first time in the direction of the reflector 504. The reflector 504 reflects the light from the grating 502 back to the grating 502 where it is coupled to the output beam 510 by a second diffraction.

FIG. 5B shows a wavelength-dispersive optical system 520 that includes a diffraction grating disposed in a configuration referred to hereafter as a Littrow configuration. An input light beam 524, that may be approximately collimated with a dimension 526 in the plane of FIG. 5B, is coupled to an output light beam 528 by a single diffraction from the grating 522.

One of the wavelength-dispersive optical systems 500 and 520 may be used in the MUX 400 to couple the ports 408A-408C and the port 416.

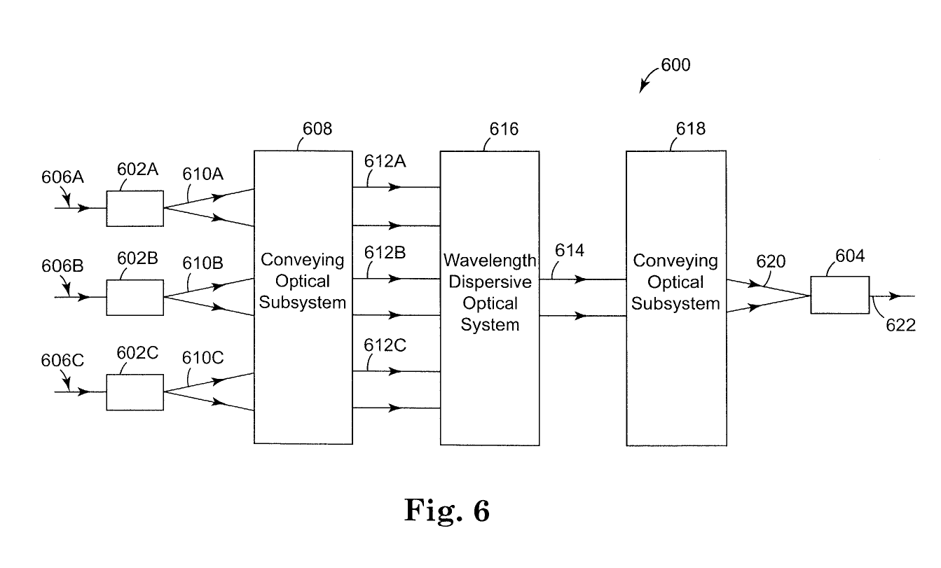

Another embodiment of a MUX 600, illustrated in FIG. 6, may also be used to couple light entering a plurality of single-channel ports 602A-602C to a multi-channel port 604. Signals with different frequencies may be carried to the single-channel ports 602A-602C by input optical fibers 606A-606C. The frequencies of the signals may be assigned according to the ITU convention described above. Light travels from the ports 602A-602C to a first, converging optical subsystem 608 that collimates the divergent free space beams 610A-610C. Collimated output beams 612A-612C exiting the first converging optical subsystem 608 are coupled to a collimated, multi-channel beam 614 by a wavelength-dispersive optical system 616 that may include, for example, a transmission diffraction grating, a prism and/or a reflection grating. The multi-channel beam 614 is focused by a second, converging optical subsystem 618 onto a multi-channel port 604. The multi-channel port 604 couples the multi-channel, converging free-space output 620 of the second optical subsystem 618 to a multi-channel fiber 622.

Individual channels of a multichannel signal may also be spatially separated by the MUX 600 if the beam directions of the embodiment illustrated in FIG. 6 are reversed.

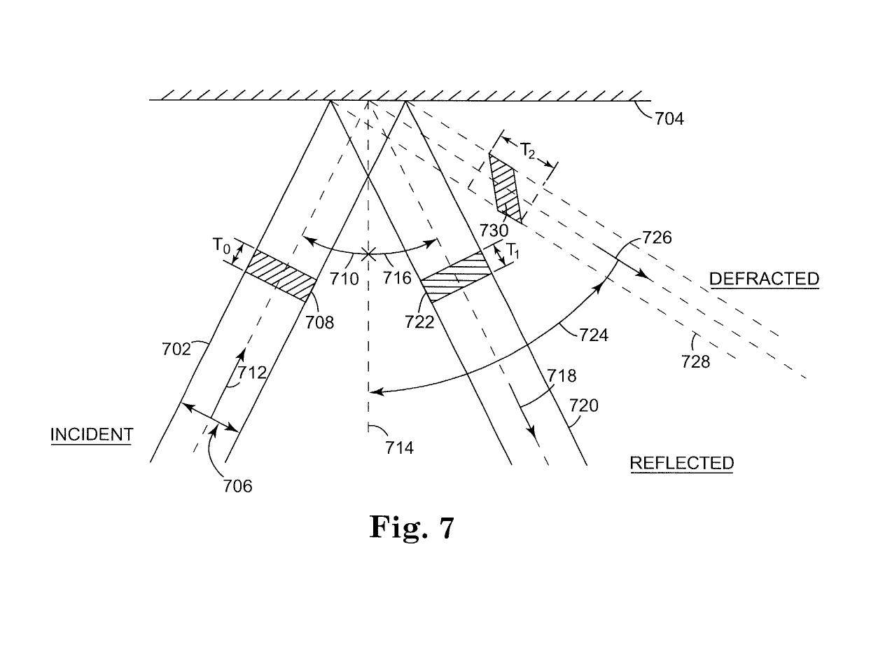

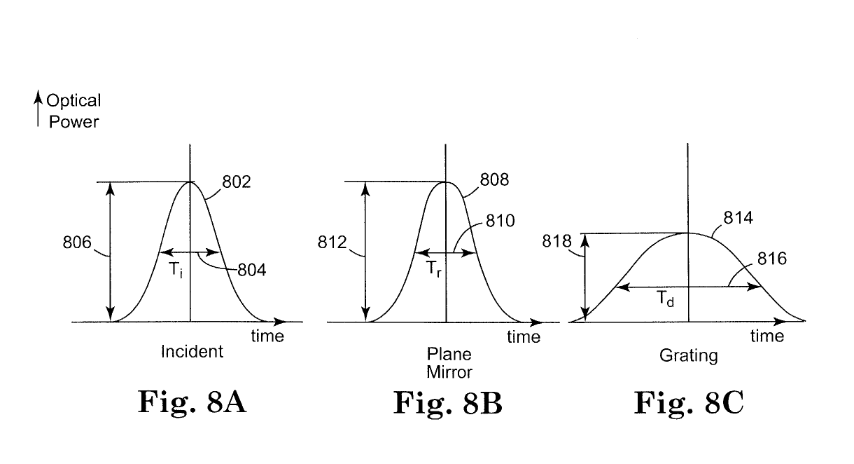

A number of mechanisms may serve to distort the beams travelling through the MUX 400, 600. For example, the phase fronts of a light beam that is diffracted by a diffraction grating are commonly tilted out of a plane that is normal to the propagation direction. This distortion may be understood with reference to FIG. 7 and FIG. 8.

FIG. 7 is a schematic representation of a collimated beam 702 interacting with a plane surface 704 that may be a mirror or a diffraction grating. We assume here that there is no wavefront distortion in the incident beam. The incident light pulse 708 has a temporal duration, T₀, that is graphically represented by the spatial extent of the pulse 708 along the beam propagation direction 712.

If the surface 704 is a mirror, Snell's Law applies and the angle 710 between the propagation direction 712 of the incident beam and the normal 714 to the surface 704 is equal to the angle 716 between the normal 714 and the propagation direction 718 of the reflected beam 720. In this case, the reflected pulse 722 has a duration, T₁, that is equal to the duration, T₀, of the representative incident pulse 708.

If the planar surface 704 is a diffraction grating, however, the angle 724 between the surface normal 714 and the direction of propagation 726 of the diffracted beam 728 is, in general not equal to the angle of incidence 710. In this case, the diffracted pulse 730 is temporally broadened and has a duration, T₂, that is greater that the incident pulse duration, T₀. Diffractive pulse broadening effects are deleterious and may cause individual pulses to overlap in an optical information signal, and may cause signal to noise ratio for a single pulse to be reduced.

FIG. 8A shows a graph of a typical Gaussian input pulse 802 before interacting with a diffraction grating. The full width at half maximum (FWHM) duration, τᵢ, 804 of the incident pulse 802 may be defined as the interval between the points in the pulse where the light intensity is reduced to half of its peak value 806. FIG. 8B shows a graph of a mirror-reflected pulse 808 while FIG. 8C shows a grating-diffracted pulse 814. Assuming near-unity amplitude coefficients for reflection and diffraction, the FWHM duration, τᵣ, 810 of the reflected pulse 808 is substantially equal to the FWHM duration, τᵢ, 804 of the input pulse 802 and the peak amplitude 812 is unchanged. In contrast, the FWHM duration, τ_{d}, 816 of the grating-reflected pulse 814 is significantly greater than the FWHM duration 804 of the input pulse 802 while the peak amplitude 818 is reduced relative to the peak amplitude 806.

If the wavelength dispersive optical system 404 includes a grating, the broadening of pulses as they travel through the MUX 400 may be reduced by decreasing the diameter of the incident beam on the diffraction grating. The diameter of the beam incident on the grating is determined by the distance between the exit plane of the I/O ports 408A-C and 416 and the first principal plane of the converging optical system 402, and also by the divergence angles of the beams 410A-410C as they exit the ports. The distance between the I/O plane and the converging optical system is typically equal to the focal length of the converging optical subsystem 402. Thus, shortening the focal length of the converging optical subsystem 402 reduces the diameter of the collimated beams 412A-412C that are incident on a grating that may be included in the wavelength dispersive optical system 404. There is a lower limit on the focal length, however, due to the requirement that the physical separation between beams at the I/O plane be equal to the physical distance between ports 408A-408C and 418. This distance is generally equal to or greater than the fiber cladding diameter, typically 125 μm for single-mode 1.5 μm communications fiber. Lenses with focal lengths long enough to obtain this separation at the I/O plane are generally not capable of reducing pulsewidth broadening effects to the level desired for many WDM and DWDM applications.

The diameter of the collimated beam at the grating is also affected by the diameter of the waveguides that are typically included in the ports 408A-408C and 416. Light leaving a port typically diverges at an angle that is inversely proportional to the waveguide dimension, expanding until it reaches the collimating optic. According to the present invention, however, the divergence of the light beam may be decreased by expanding the waveguide mode before it leaves the port. The mode size in one direction may increased by a larger factor than the mode size in a second direction. Pulsewidth broadening effects are most sensitive to expansion in the plane of diffraction, for example the plane of the page in FIGS. 5A and 5B. In one particular embodiment, a symmetric mode expansion is accomplished with an expanded core fiber. In other embodiments, the mode may expand more in one dimension than another direction, for example using an elliptical core fiber or a planar waveguide structure.

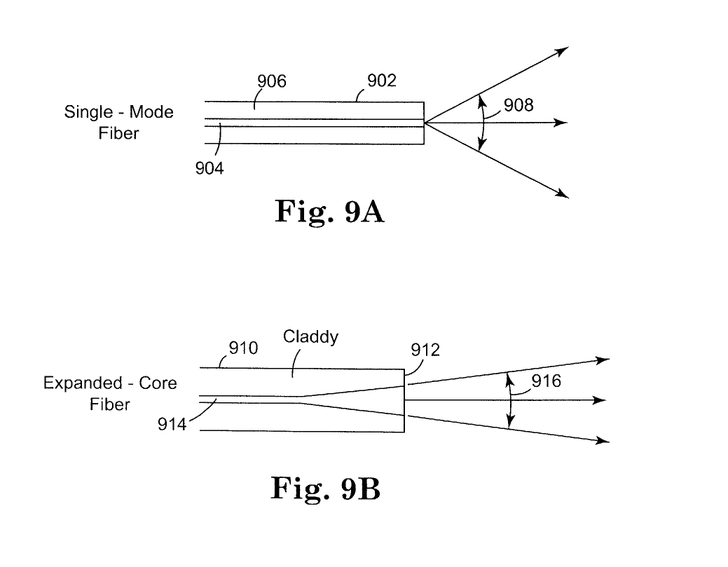

FIG. 9A shows a cross-sectional view of a light beam emerging from a conventional single-mode fiber 902 with constant core diameter. In a typical telecommunications fiber, a 9.3 μm silica core 904 is surrounded by a silica cladding layer 906 of lower index with an outside diameter of approximately 125 μm. Light emerging from the fiber end diverges at an angle 908 of approximately 12.60. In the expanded-core fiber 910 of FIG. 9B the mode diameter at the output end 912 has been increased by slowly increasing the size of the core 914 towards the end 912. As a result, the divergence angle 916 of the beam leaving the fiber may be significantly reduced relative to the divergence angle produced by the constant-core fiber 902.

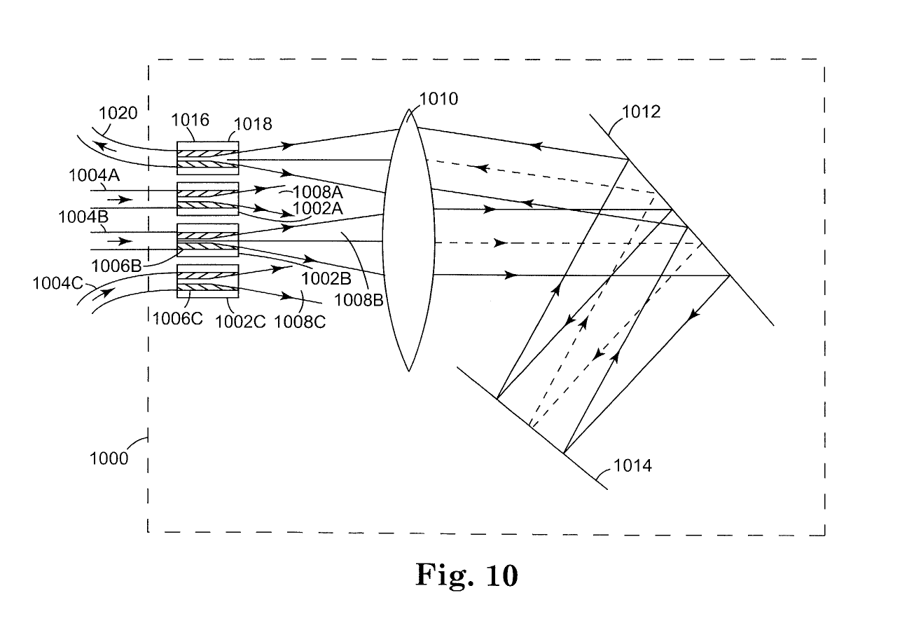

Expanded-core fibers may be used in the single and multi-channel ports of Littrow and Littman-Metcalf WDM and DWDM multiplexers to minimize pulse-broadening effects. One particular embodiment of a multiplexer 1000 according to the present invention is shown schematically in FIG. 10, in which expanded core fibers are used in the ports to reduce the diameter of the collimated beams at the grating. The invention significantly reduces pulse-broadening in the MUX.

In FIG. 10, a plurality of single-channel signals are transported to the single-frequency ports 1002A-1002C by conventional optical fibers 1004A-1004C. These ports contain expanded core fibers 1006A-1006C with their large-core ends directed towards a collimating optical system 1010. The free space beams 1008A-1008C emerging from the single-frequency ports have a reduced angle of divergence. These beams are collimated by a converging optical system 1010 and are diffracted by a diffraction grating 1012 that is tilted relative to the input direction so that the diffracted beams have a wavelength-dependent angular relationship to the surface normal. Light travelling from the grating 1012 is reflected back to the grating 1012 by a planar mirror 1014. After a second grating diffraction, the angular direction and displacement of the single wavelength input beams are modified in such a way that they are focused by the converging optical system 1010 onto the large diameter end of an expanded core output fiber 1016 at a multi-channel port 1018. The multichannel signal is carried from the multi-channel port 1018 by an optical fiber 1020.

It will be appreciated that the MUX 1000 may also be used as a demultiplexer (DMUX). In this case, the beam directions in FIG. 10 are reversed with a multi-channel signal entering the DMUX through the multi-channel port 1018. Individual channels are physically separated by the grating 1012 and coupled to the single-channel ports 1002A-1002C. Single-channel signals are carried away from the single-channel ports 1002A-1002C by the optical fibers 1004A-1004C. A similar improvement in pulse-width broadening effects is obtained when the MUX 1000 is used as a DMUX. The converging optical system 1010 is depicted as a single lens in FIG. 10, but may include other focusing elements such as diffractive optical elements and microlens arrays, for example. Combinations of elements including, for example, a lenslet array and a conventional focusing lens may be advantageous in some designs and may be used without violating the spirit of the invention. These combinations may reduce optical aberrations and/or offer reduced pulse-width broadening with respect to single-lens designs.

While the expanded-core fiber of FIG. 9 provides a symmetric beam expansion, alternative embodiments of the invention may utilize beam expanders where the mode expands to a greater extent in one dimension than in another. Pulsewidth broadening effects are primarily dependent on the beam cross section in the grating plane of incidence (parallel to the page in FIG. 10). The pulsewidth broadening effects are far less influenced by the beam dimension in the orthogonal direction (perpendicular to the page). Thus, integrated optics or elliptical-cored fiber mode expanders may be used in place of the symmetric, circular-cored expanded mode fibers 1006A-1006C and 1016 in alternative embodiments of the invention. In this case, the increase in the waveguide mode cross section is greater in the grating plane of incidence than in the perpendicular direction. An asymmetric converging optical system may be used to collimate the beam in both planes and focus the return beam(s) into the output ports.

As noted above, the present invention is applicable to MUX and DMUX assemblies in fiber optic communications systems and is particularly useful in reducing pulse-broadening effects. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical device, comprising:
a multi-channel port;
a plurality of single-channel ports with at least one of the multi-channel and the single-channel ports including a waveguide with a cross-sectional dimension that is smaller at an internal portion of the waveguide than at an aperture of the waveguide; and
an optical system with wavelength-dependent, free-space paths that couple light between the single-channel ports and the multi-channel ports, the waveguide aperture coupled to one of the wavelength-dependent, free-space paths.

2. The optical device as cited in claim 1, wherein the waveguide aperture cross-sectional dimension is increased relative to the internal portion in a single direction.

3. The optical device as recited in claim 1, wherein the waveguide aperture cross-sectional dimension is increased relative to the internal portion in two, orthogonal directions.

4. The optical device as recited in claim 1, wherein light propagates from the plurality of single-channel ports to the multichannel port.

5. The optical device as recited in claim 1, wherein light propagates from the multi-channel port to the plurality of the single-channel ports.

6. The optical device as recited in claim 1, wherein the optical system includes a single converging optical subsystem and a wavelength dispersive assembly, the single converging optical subsystem coupling the single channel ports and the multichannel port to the wavelength-dispersive assembly.

7. The optical device as recited in claim 6, wherein the converging optical subsystem includes a lens that collimates light propagating towards the wavelength-dispersive assembly and focuses light propagating from the wavelength-dispersive assembly along at least one of the free-space optical paths.

8. The optical device as recited in claim 6, wherein the converging optical subsystem includes a lens array.

9. The optical device as recited in claim 6, wherein the wavelength-dispersive assembly is a diffraction grating disposed in a Littrow configuration.

10. The optical device as recited in claim 6, wherein the wavelength-dispersive assembly is a diffraction grating and a mirror disposed in a Litmann-Metcalf configuration.

11. The optical device as recited in claim 1, wherein the multi-channel and single-channel ports are disposed in a linear array.

12. The optical device as recited in claim 11, wherein the multi-channel port is located at one end of the linear array.

13. The optical device as recited in claim 1, wherein the optical system contains a wavelength-dispersive element, a first converging optical subsystem disposed on the wavelength dependent paths between the plurality of single-channel ports and the wavelength-dispersive element, and a second converging optical subsystem disposed on the wavelength-dependent paths between the multi-channel port and the wavelength-dispersive element.

14. The optical device as recited in claim 13, wherein light propagates from the plurality of single-channel ports to the multi-channel port.

15. The optical device as recited in claim 16, wherein light propagates from the multi-channel port to the plurality of single-channel ports.

16. The optical device as recited in claim 13, wherein the wavelength-dispersive element is a diffraction grating.

17. The optical device as recited in claim 13, wherein the diffraction grating is a transmission diffraction grating.

18. The optical device as recited in claim 13, wherein the first and second converging optical subsystems each include at least one lens that interacts with light propagating along at least one free space optical path.

19. The optical device as recited in claim 13, wherein at least one of the first and second converging optical subsystems include a lens array.

20. An optical wavelength division multiplexed (WDM) communications system, comprising:
a WDM transmitting unit;
a WDM receiving unit;
and an optical transport system coupled to transmit a multi-channel optical signal from the transmitting unit to the receiving unit,
at least one of the transmitting unit and the receiving unit including an optical device, including:
a multi-channel port;
a plurality of single-channel ports with at least one of the multi-channel and the single-channel ports including a waveguide with a cross-sectional dimension that is smaller at an internal portion of the waveguide than at an aperture of the waveguide; and
an optical system with wavelength-dependent, free-space paths that couple light between the single-channel ports and the multi-channel ports, the waveguide aperture coupled to one of the wavelength-dependent, free-space paths.

21. The system as recited in claim 20, wherein the optical transport system is a fiber optic network.

22. The system as recited in claim 21, wherein at least one of the channels in the multi-channel signal has a wavelength greater than 1.5 μm and less than 1.65 μm.

23. The system as recited in claim 21, wherein at least one of the channels in the multi-channel signal has a wavelength greater than 1.3 μm and less than 1.4 μm.

24. The system as recited in claim 21 wherein the fiber optic network includes at least one optical fiber amplifier.

25. The system as recited in claim 21 wherein the fiber optic network includes at least one channel power equalizer.

26. The system as recited in claim 21 wherein the fiber optic network includes at least one switching device selected from the group of optical on/off switches, optical passing switches, static optical add-drop multiplexers, configurable optical add-drop multiplexers, and optical cross-connect switches.

27. The system as recited in claim 20, wherein the optical device is coupled between a plurality of light sources operable at different wavelengths on an input side and the optical transport system at an output side, light from the plurality of light sources being combined into a multi-channel signal in the optical device.

28. The system as recited in claim 20, wherein the optical device is coupled between the optical transport system at an input side, and a plurality of receivers operable at different wavelengths on an output side, the light from the multi-channel source being separated into single-channel signals within the device.

29. The system as recited in claim 20, wherein the optical transport system is a free space link.

30. The system as recited in claim 29, wherein at least one of the channels in the multi-channel signal has a wavelength that is greater than 0.75 μm and less than 1.1 μm.

31. The system as recited in claim 29, wherein at least one of the transmitting unit and the receiving unit includes a telescope.

32. A method of forming a multi-channel optical signal, which comprises:
optically coupling a plurality of single-channel ports to a multi-channel port along wavelength-dependent free-space optical paths; and
reducing the angular spread of the free-space optical path at a coupling aperture of at least one of the plurality of single-mode ports and the multi-frequency port by including a waveguide with a cross-sectional dimension that is smaller at an internal portion of the waveguide than at the aperture of the waveguide in the port.

33. The method recited in claim 32, including propagating light from the multi-channel port to the plurality of single-channel ports.

34. The method recited in claim 32 including propagating light from the plurality of single-channel ports to the multi-channel port.

35. The method recited in claim 32, including interacting the light travelling along the free-space paths with a converging optical subsystem.

36. The method recited in claim 32, including interacting the light travelling along the free-space paths with a plurality of converging optical subsystems.

37. The method recited in claim 32, including directing the light along the plurality of the free-space paths with a dispersive optical subsystem.

38. The method recited in claim 37, wherein directing the light along the plurality of the free-space paths includes illuminating a diffraction grating and a mirror in a Littman-Metcalf configuration.

39. The method recited in claim 37, wherein directing the light along the plurality of the free-space paths illuminating a diffraction grating in a Littrow configuration.
